(19) United States
(12) Patent Application Publication
(10) Pub. No.: US 2026/0353150 A1
(43) Pub. Date: Nov. 5, 2026

(54) DEACTIVATED SECONDARY CELL MEASUREMENT VIA SWITCHING

(71) Applicant: QUALCOMM Incorporated, San Diego, CA (US)

(72) Inventors: Nazmul ISLAM, Littleton, MA (US); Changhwan PARK, San Diego, CA (US); Stefan BRUECK, Neunkirchen am Brand (DE); Valentin Alexandru GHEORGHIU, Yokohama-shi (JP); Prashant SHARMA, San Marcos, CA (US)

(21) Appl. No.: 19/572,770

(22) Filed: Mar. 19, 2026

Related U.S. Application Data
(60) Provisional application No. 63/800,426, filed on May 5, 2025.

(51) Int. Cl. H04W 24/10; H04L 5/00; H04W 56/00

(52) U.S. Cl. CPC H04W 24/10; H04L 5/0053; H04W 56/0015

(57) ABSTRACT

Certain aspects of the present disclosure provide techniques for performing measurements in deactivated secondary cells. An example method, performed at a user equipment (UE), generally includes receiving first signaling configuring the UE with a plurality of measurement occasions, selecting one of the measurement occasions from the plurality of measurement occasions to perform measurements on a deactivated first secondary cell (SCell) within an SCell measurement cycle, interrupting operation on at least one of a primary cell (PCell) or an activated second SCell, performing the measurements on the deactivated first SCell according to the measurement occasion selected by the UE, during the interruption, and transmitting a report based on the measurements.

### CROSS-REFERENCE TO RELATED APPLICATIONS

This application claims priority to U.S. Provisional Application No. 63/800,426, filed May 5, 2025, which are hereby incorporated by reference herein.

### FIELD OF THE DISCLOSURE

Aspects of the present disclosure relate to wireless communications, and more particularly, to techniques for performing measurements in deactivated secondary cells.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving first signaling configuring the UE with a plurality of measurement occasions, selecting one of the measurement occasions from the plurality of measurement occasions to perform measurements on a deactivated first secondary cell (SCell) within an SCell measurement cycle, interrupting operation on at least one of a primary cell (PCell) or an activated second SCell, performing the measurements on the deactivated first SCell according to the measurement occasion selected by the UE, during the interruption, and transmitting a report based on the measurements.

Another aspect provides a method for wireless communication at a network entity. The method includes transmitting first signaling configuring a user equipment (UE) with measurement occasions to perform measurements on a deactivated first secondary cell (SCell) within an SCell measurement cycle, interrupting operation on at least one of a primary cell (PCell) or an activated second SCell for the UE to perform measurements on the deactivated first SCell, wherein the measurements are performed within an SCell measurement cycle according to one of the plurality of measurement occasions selected by the UE, and receiving a report, from the UE, based on the measurements.

Another aspect provides a method for wireless communication at a user equipment (UE). The method includes receiving first signaling configuring the UE with measurement occasions to perform measurements on a deactivated first secondary cell (SCell), interrupting operation on at least one of a primary cell (PCell) or an activated second SCell, wherein the interruption is limited by a metric associated with acknowledgement feedback determined based on a rule involving one or more factors, performing the measurements on the deactivated first SCell, during the interruption, and transmitting a report based on the measurements.

Another aspect provides a method for wireless communication at a network entity. The method includes transmitting first signaling configuring a user equipment (UE) with measurement occasions to perform measurements on a deactivated first secondary cell (SCell), interrupting operation on at least one of a primary cell (PCell) or an activated second SCell for the UE to perform measurements on a deactivated SCell within an SCell measurement cycle according to one of the configured measurement occasions, wherein the interrupting is limited by a metric associated with acknowledgement feedback determined based on a rule involving one or more factors, and receiving a report, from the UE, based on the measurements.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts examples of measurement windows.

FIG. 6 depicts an example of carrier aggregation (CA).

FIG. 7 depicts an example of switching to perform measurements in a secondary cell (SCell).

FIG. 8 depicts an example of switching to perform measurements in an SCell.

FIG. 9 depicts an example call flow diagram, in accordance with certain aspects of the present disclosure.

FIG. 10 depicts an example of switching to perform measurements in an SCell, in accordance with aspects of the present disclosure.

FIG. 11 depicts an example of switching to perform measurements in an SCell, in accordance with aspects of the present disclosure.

FIG. 12 depicts an example of switching to perform measurements in an SCell, in accordance with aspects of the present disclosure.

FIG. 13 depicts a method for wireless communications.

FIG. 14 depicts a method for wireless communications.

FIG. 15 depicts a method for wireless communications.

FIG. 16 depicts a method for wireless communications.

FIG. 17 depicts aspects of an example communications device.

### DETAILED DESCRIPTION

Aspects of the present disclosure relate to wireless communications, and more particularly, to techniques for performing measurements in deactivated SCells.

In wireless systems that support carrier aggregation (CA), a user equipment (UE) may be configured with multiple component carriers (e.g., a primary cell or PCell and secondary cells or SCells).

Certain wireless systems support supplemental downlink (SDL) channels, via carrier aggregation (CA). For example, in some cases, a low band (e.g., <2 GHz) may serve as the SDL channel. If the serving channel is also a low band (e.g., as is the case in low-low band CA), the UE may either remain in a frequency division duplexed (FDD) band or the SDL band.

The SDL band will act as a secondary cell (SCell) for the UE in this type of CA scenario. This solution may be especially useful in scenarios where the UE cannot simultaneously operate in the SDL band and in an uplink (UL) band of the FDD band due to various factors (e.g., adjacency between DL & UL).

To save power or when traffic is low, some SCells may be deactivated. However, to ensure that deactivated SCells remain suitable for future use (e.g., still have acceptable signal quality and the UE does not need to measure SCell for too long during the SCell activation procedure before it gets ready to communicate via SCell), the UE may occasionally perform measurements of reference signals (RSs) in the SCells, such as synchronization signal blocks (SSBs).

In some cases, an SCell (SDL band) may need to be configured before it can be used. Measurement of (SSBs on) a deactivated SCell may reduce an SCell activation timeline (e.g., by providing timing information). If a UE has not recently measured a deactivated SCell, that SCell may be considered “unknown” to the UE. In this case, the UE may require (measurement of) more synchronization signal block (SSB) samples to update its automatic gain control (AGC) and loop during SCell activation. On the other hand, if the UE has recently measured an SCell, that SCell may be considered “known” and the UE may require less SSB samples during SCell activation.

Systems typically allow a UE to interrupt operation in a primary cell (PCell) or active SCells in order to perform measurement in a deactivated SCell. In this context, an interruption duration for measurement on a deactivated SCell generally refers to a time period during which the UE temporarily stops transmitting or receiving on its active serving cells (PCell and/or active SCell) to perform measurements on a currently deactivated SCell.

The interruption is typically allowed in a measurement window occasions, configured via an SSB-based RRM Measurement Timing Configuration (SMTC), and adjacent slots. Unfortunately, there is no clear definition of which SMTC occasion within an SCell measurement cycle period that a UE should select for measurement and interruption. Due to the uncertain nature of interruption, the network (e.g., a gNB) may stop scheduling that UE in the time surrounding all the SMTC occasions of the SCell (to avoid potential collisions). This uncertainty may cause inefficient resource utilization, scheduling inefficiency, and/or unnecessary latency.

Aspects of the present disclosure, however, provide mechanisms that may help remove such uncertainty. For example, aspects of the present disclosure provide various rules that may define how a UE selects an SMTC occasion for measuring a deactivated SCell. By applying the same rule, the network may stop scheduling the UE only in the time surrounding the SMTC occasion selected according to the rule. Deterministic or reported selection of SMTC occasions may allow the network to avoid unnecessary scheduling suspension. As a result, the techniques proposed herein may help achieve better resource utilization and improve overall performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

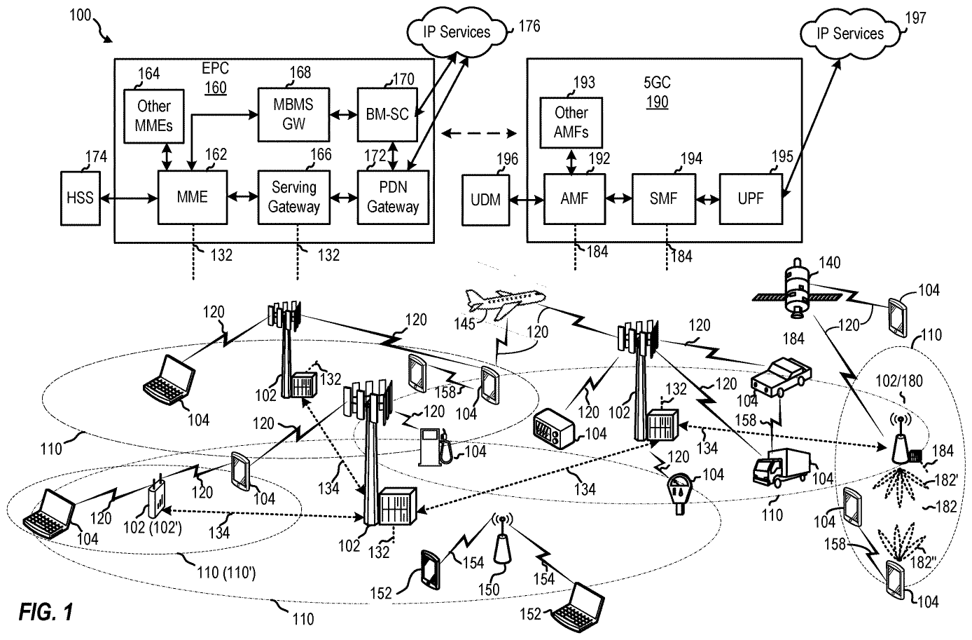

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

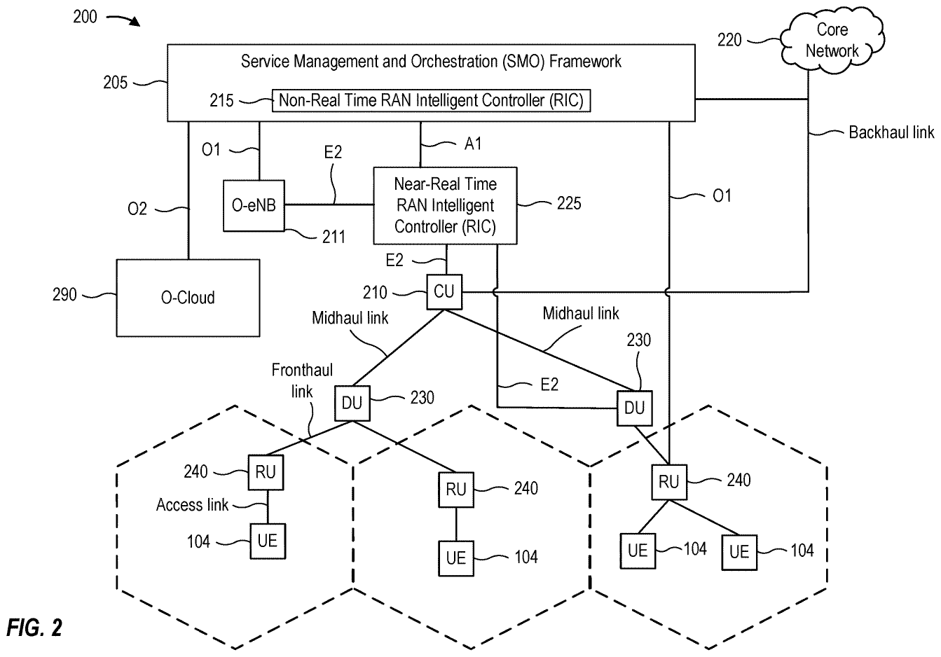

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

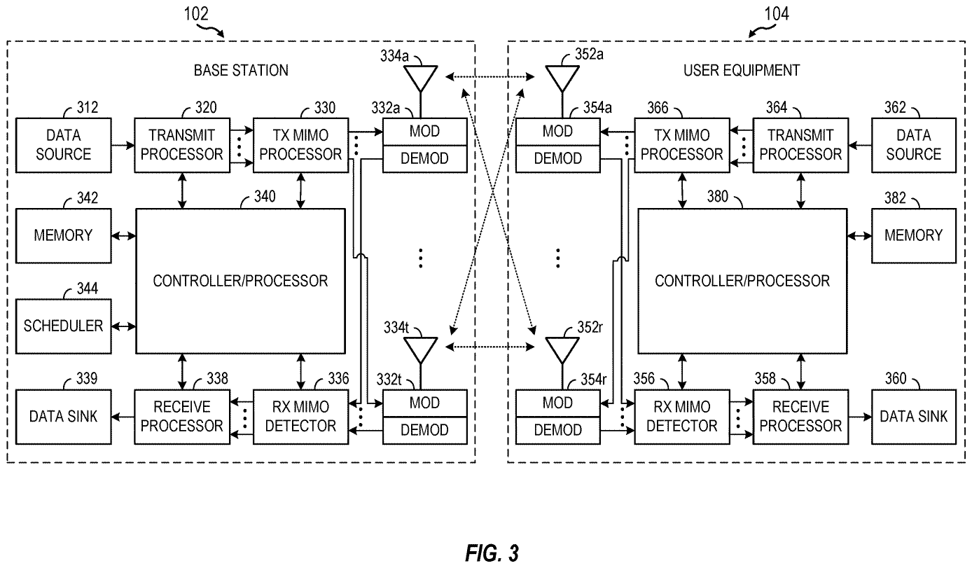

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

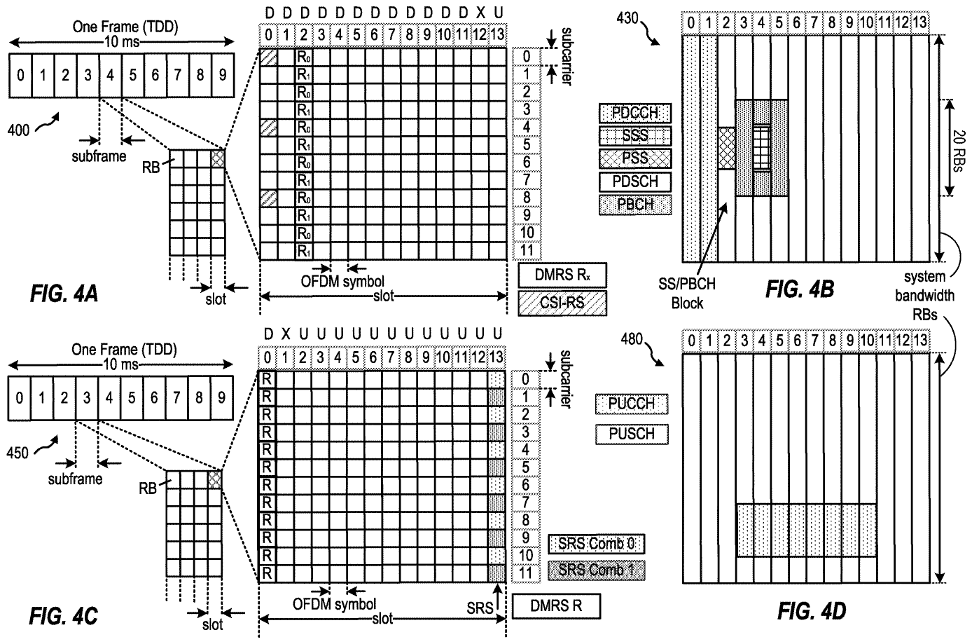

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Measurement Gaps

To ensure good radio conditions, the network may configure time periods, referred to as measurement gaps (MGs), for the UE to perform inter-frequency or inter radio access technology (inter-RAT) measurement, beam measurement, and/or intra-frequency measurement when a UE's active bandwidth part (BWP) does not contain a synchronization signal block (SSB).

When a UE is configured to periodically/aperiodically measure and/or decode SSBs of neighboring cells, the UE typically expects to obtain various kinds of information in MGs, depending on a particular case. According to a first case, the UE is expected to obtain a metric indicative of signal strength of neighboring cells, such as RSRP and/or RS received quality (RSRQ). According to a second case, the UE is expected to obtain basic information of neighbor cells, such as a cell global identifier (CGI).

For the first case, the UE does not need to decode the SSB from neighbor cells, since it just acquires signal strength, which may be obtained relatively quickly as the SSB does not need to be decoded. The UE conducts measurement in a configured MG, in which the UE is not expected to receive on the downlink (e.g., PDCCH or PDSCH) or to transmit on the uplink (e.g., PUCCH, SRS, PUSCH), except for physical random access channel (PRACH) transmissions. For the second case, the UE decodes SSB of neighbor cells, in order to obtain master information block (MIB) information and/or system information block (SIB) information, in which the UE can obtain the CGI. A relatively long time may be required to accomplish this decoding, which may be longer than the configured MG length, particularly for UEs with relatively low processing capability.

### Overview of SMTC Windows

SSB periodicity may be configured for different cells in the range of 5, 10, 20, 40, 80 or 160 ms. However, UEs may not need to measure cell signals with the same periodicity as the SSBs. Rather, an appropriate measurement periodicity may be configured according to channel conditions. This approach may be desirable in order to help to avoid unnecessary measurements and reduce the power consumption on the UE.

In some cases, a UE may be configured with an SSB-based RRM Measurement Timing Configuration (SMTC). SMTC may indicate a measurement periodicity and timings of SSBs that the UE can use for measurements.

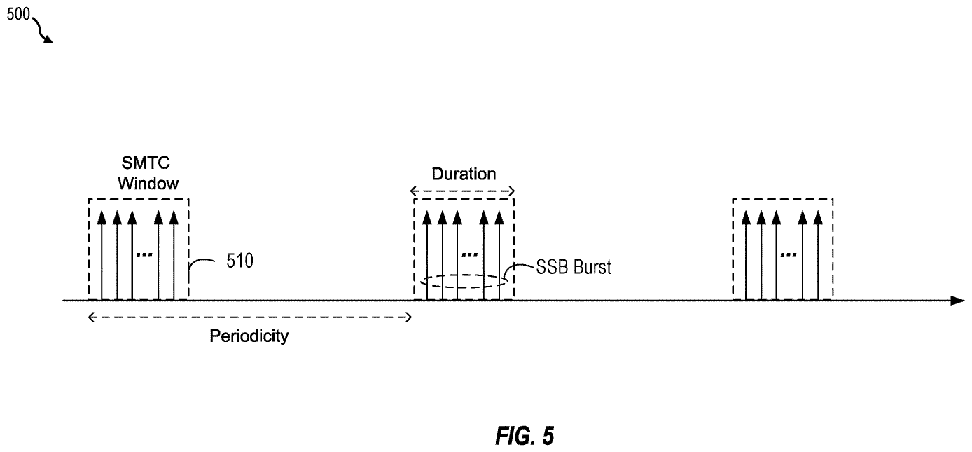

As illustrated in diagram 500 of FIG. 5, an SMTC may define SMTC windows 510 during which a UE can measure a burst of SSBs for a cell. As illustrated, SMTC window occasions may have a certain duration and may occur with a given periodicity.

For example, the SMTC window periodicity may be in the same range of SSB periodicity (e.g., 5, 10, 20, 40, 80 or 160 ms) and the SMTC window duration may be set to 1, 2, 3, 4, or 5 ms (e.g., according to the number of SSBs transmitted on the cell being measured). Further different SMTC windows may be configured such that different cells are measured with different window periodicities and/or durations.

When a UE is configured with an SMTC window by the network (e.g., via a gNB), the UE detects and measures the SSBs within the SMTC window. The UE may then report the measurement results back to the network.

### Overview of Carrier Aggregation for Supplemental DL

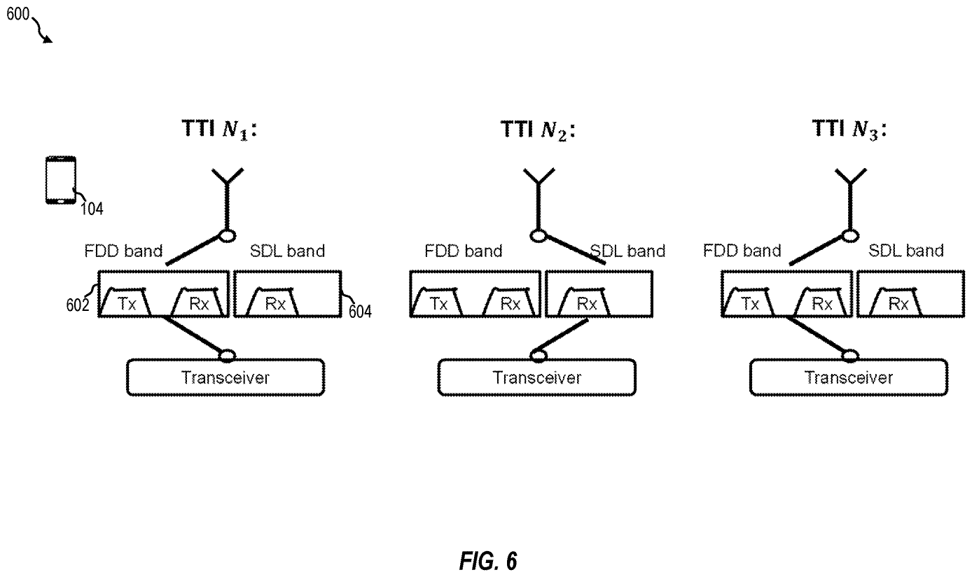

As illustrated in diagram 600 of FIG. 6, certain wireless systems support supplemental downlink (SDL) channels, via carrier aggregation (CA). As illustrated, the UE may be configured with an FDD band 602 for both uplink (Tx) and downlink (Rx) and with an SDL band 604 for SDL (Rx only). As noted above, in some cases, a low band (e.g., <2 GHz) may serve as the SDL channel.

If the serving channel is also a low band (e.g., as is the case in low-low band CA), the UE may either remain in a frequency division duplexed (FDD) band or the SDL band. In the illustrated example, the UE remains in the FDD band during a first transmission time interval (TTIs) N1. The UE then switches to the SDL band during a second TTI N2 and then switches back to the FDD band for a third TTI N3.

### Aspects Related to Deactivated SCell Measurement Via Switching

The SDL band will act as a secondary cell (SCell) for the UE in this type of CA scenario. This solution may be especially useful in scenarios where the UE cannot simultaneously operate in the SDL band and in an uplink (UL) band of the FDD band due to various factors (e.g., adjacency between DL & UL).

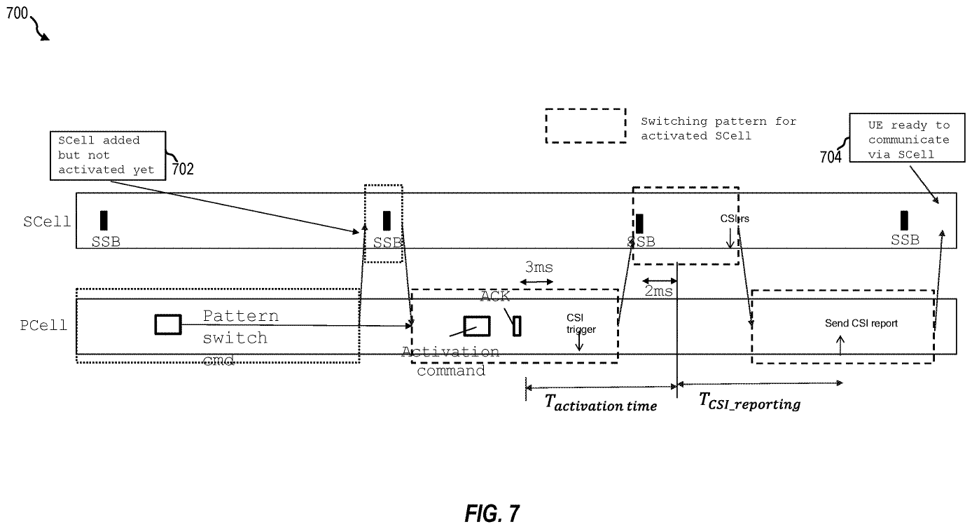

A illustrated in diagram 700 of FIG. 7, an SCell may need to be activated before it can be used. The illustrated example assumes an SCell that has been added, but not yet activated, as indicated at 702.

Measurement of (SSBs on) a deactivated SCell may reduce an SCell activation timeline. If a UE has not recently measured a deactivated SCell, that SCell may be considered “unknown” to the UE. In this case, the UE may switch to the SCell and measure CSI-RS in the SCell. After sending a CSI report (in the PCell), the UE may be ready to communicate via the SCell, as indicated at 704.

As noted above, systems typically allow a UE to interrupt operation in a primary cell (PCell) or active SCell in order to perform measurement in a deactivated SCell. In this context, interruption generally refers to the period when the UE pauses normal transmission/reception on active cells (e.g., PCell and/or SCells) to tune to the deactivated SCell resources and take the required measurements. Such interruptions may involve suspending uplink transmissions, suspending downlink reception, retuning RF chains, and/or switching frequency bands. Such interruptions are typically shorter than a full configured measurement gap. The exact duration may be implementation specific, but the UE may be expected to avoid significant packet loss or latency.

Interruption for deactivated SCell measurement may be subject to certain expectations. For example, one such expectation may be that interruption only occurs adjacent to SCell SMTC occasions. For example, the interruption may be expected to begin a fixed duration prior to an SMTC occasion and a fixed duration after the SMTC occasion. In this context, the fixed duration could be a number (an integer or fractional number) of slots or a fixed duration in terms of time units (e.g., an integer or fractional number of ms).

During interruption for deactivated SCell measurement, there is a probability of missed acknowledgment (e.g., ACK/NACK) information. In other words, there is a risk that the UE might fail to correctly send or receive Hybrid automatic repeat request (HARQ) acknowledgments because it temporarily interrupts its normal operation to perform measurements on the deactivated SCell. In some systems, some relatively small amount of risk may be tolerated (e.g., 0.5% probability of missed ACK/NACK), because fully preventing such misses-if possible-may require prohibitively long measurement gaps.

Another expectation for interruption for deactivated SCell measurement may be that the total interruption is limited to an expectation of 0.5% miss of ACK/NACK. This threshold (of 0.5%) may be set to ensure that UE does not interrupt for too long.

In some cases, the aforementioned expectations for interruption may be applicable for certain SCell measurement cycle durations (e.g., when an SCell measurement cycle “measCycleSCell” is >=640 ms). In other cases (e.g., if measCycleSCell is <640 ms), the UE may be expected to set its RF circuits in such a way to receive both PCell and SCell. If measCycleSCell >=640 ms, the UE may turn off its RF circuits corresponding to SCell to save power.

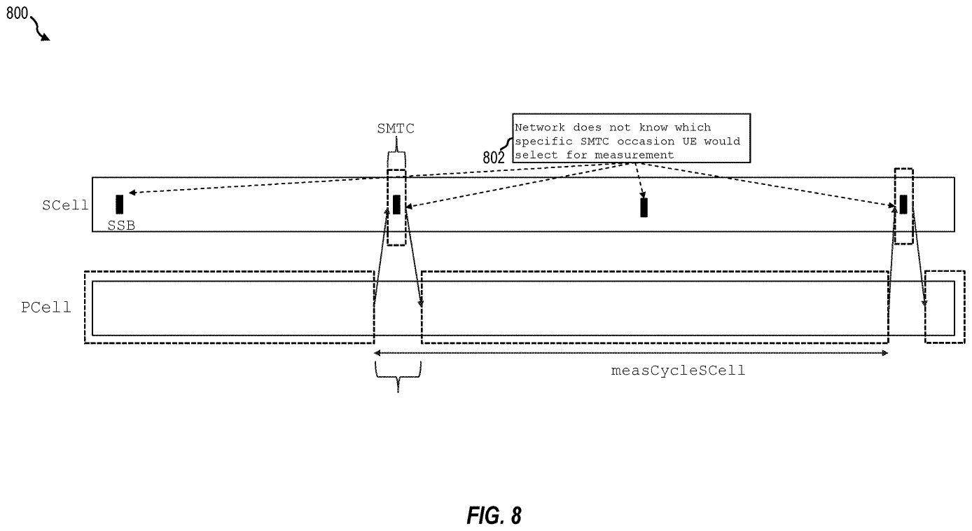

As illustrated in diagram 800 of FIG. 8, interruption to measure deactivated SCells is typically allowed in SMTC window occasions and adjacent slots. Unfortunately, there is no clear definition of which SMTC occasion within an SCell measurement cycle period that a UE should select for measurement and interruption. As a result, as indicated in FIG. 8, the network typically does not know which specific SMTC occasions the UE would select for measurement, as indicated at 802.

Due to the uncertain nature of interruption, the network (e.g., a gNB) may stop scheduling that UE in the time surrounding all the SMTC occasions of the SCell (to avoid potential collisions).

Aspects of the present disclosure, however, provide mechanisms that may help remove such uncertainty. For example, aspects of the present disclosure provide various rules that may define how a UE selects an SMTC occasion for measuring a deactivated SCell. By applying the same rule, the network and UE may be able to have a common understanding regarding the particular SMTC occasion that UE should select for measurement.

While examples described herein involve low band to low band CA via switching, the mechanisms proposed herein may be broadly applied to most any scenario where a UE's periodic measurement causes interruption to other serving cells or uplink of the same serving cell.

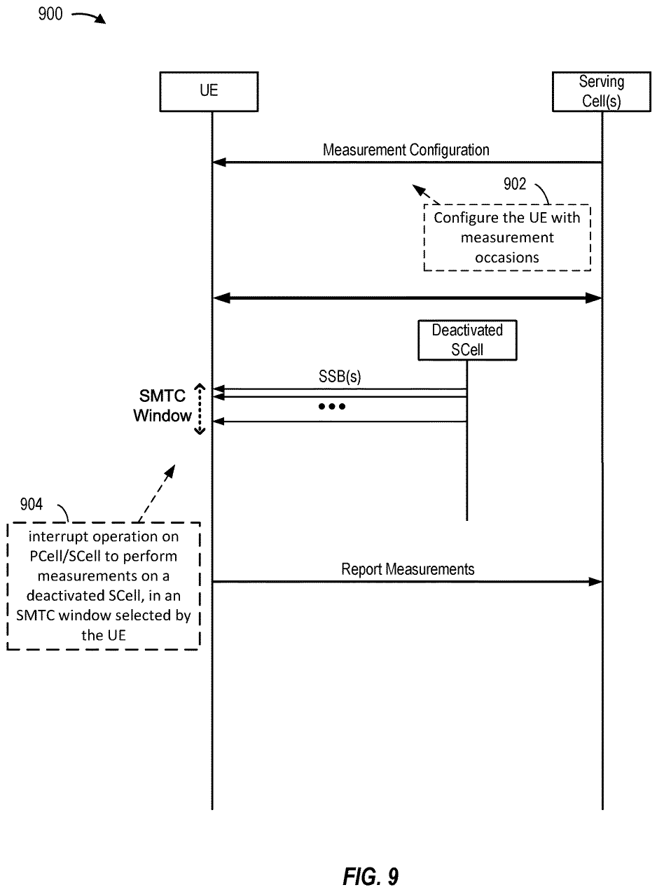

The mechanisms for deactivated SCell measurement proposed herein may be understood with reference to the call flow diagram 900 shown in FIG. 9.

In some aspects, the serving cell(s) shown in FIG. 9 (PCells and/or active SCells) may be an example of network entities, such as the BS depicted and described with respect to FIGS. 1 and 3 or a disaggregated base station depicted and described with respect to FIG. 2. Similarly, the UE shown in FIG. 9 may be an example of UE 104 depicted and described with respect to FIGS. 1 and 3. However, in other aspects, UE 104 may be another type of wireless communications device and BS 102 may be another type of network entity or network node, such as those described herein.

As illustrated at 902, a serving cell may configure (via first signaling) the UE with measurement occasions. For example, the serving cells may configure SSB-based RRM Measurement Timing Configuration (SMTC) window occasions for performing measurements in a deactivated SCell. In this context, a measurement occasion may correspond to an SMTC window instance.

As indicated at 904, the UE may interrupt operation on the serving cells (PCell/SCell) to perform measurements on a deactivated SCell, in an SMTC window selected by the UE. For example, the UE may switch to an SDL band to perform measurements on the deactivated SCell in an SMTC occasion, selected by the UE according to a rule.

After switching back to the serving cell(s), the UE may report the measurements. The serving cell(s) may make decisions based on the reported measurements (e.g., to activate the deactivated SCell). Reporting of deactivated SCell measurements by the UE may be periodic or event driven. In cases where the reporting is event driven, then UE may not send a report during every measurement. For example, event-driven measurement reporting may be defined through measurement events configured by the network. Occurrence/detection of these events may trigger a UE to send a measurement report (e.g., when certain conditions are met).

As noted above, by applying the same rule, the network and UE may be able to have a common understanding regarding the particular SMTC occasion that the UE selects for measurement. In some cases, such a rule may be defined (e.g., in a standard specification).

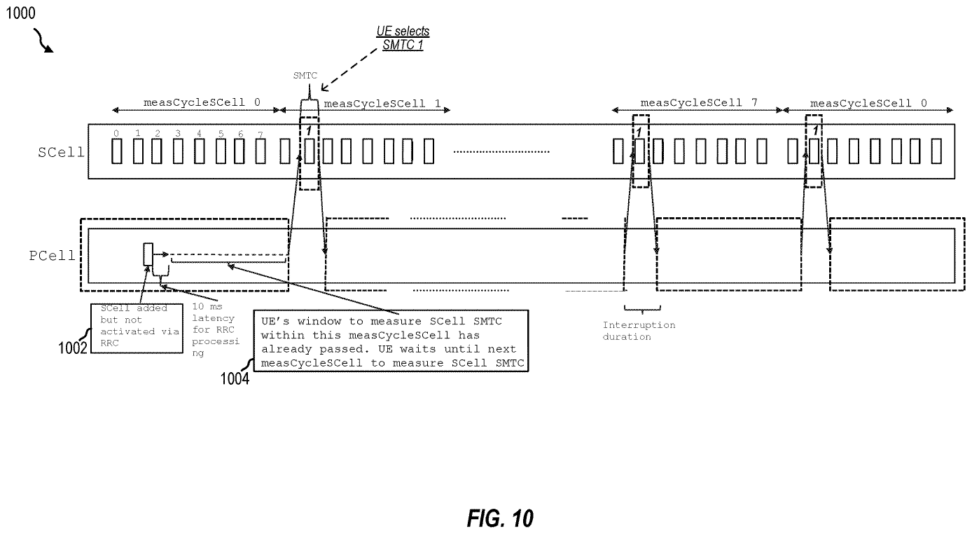

In some cases, as illustrated in diagram 1000 of FIG. 10, the UE may split every system frame into multiple measurement cycles and index them accordingly (with an index measCycleSCell_i). As indicated at 1002, the example assumes an SCell is added, but not yet activated. The rule may dictate that selection of a specific SMTC within measCycleSCell depends on an SMTC period, measCycleSCell index and some type of UE identity, such as a cell radio network temporary identifier (C-RNTI). For example, the UE may use an equation:

C-RNTI mod(measCycleSCell period/SMTC period),

to select the SMTC to measure the deactivated SCell.

As indicated in FIG. 10, after the UE receives and processes an SCell addition without activation command in measCycleSCell_0, the UE may wait until its corresponding SMTC occasion of a current or next measCycleSCell (measCycleSCell_0) to measure SCell SSB and cause an interruption in PCell. In the illustrated example, there may be a 10 ms latency for RRC processing after receiving the SCell addition command. In this case, as indicated at 1004, the UE's window to measure SCell SMTC within measCycleSCell_0 has already passed. Thus, the UE may wait until a next measCycleSCell (e.g., measCycleSCell_0) to measure SCell SMTC.

It may be assumed that: measCycleSCell=1280 ms and that SMTC=160 ms. Thus, one system frame contains 8 measCycleSCells (measCycleSCell_0, measCycleSCell_1, . . . measCycleSCell_7). It may also be assumed that, applying the equation above:

C-RNTI mod(measCycleSCell/SMTC)=1.

Thus, as illustrated in FIG. 10, the UE selects SMTC 1 for interrupting to measure the deactivated SCell.

According to certain aspects, the network may explicitly configure a separate parameter (e.g., parameter_x that is different from the UE RNTI) that the UE can use that to select a specific SMTC of the deactivated SCell. For example, the network may select this parameter to balance the “SCell measurement load” among different UEs and/or to avoid the total interruption (of UEs) in PCell.

In this case, the UE may use the equation:

network configured parameter_x mod(measCycleSCell period/SMTC period),

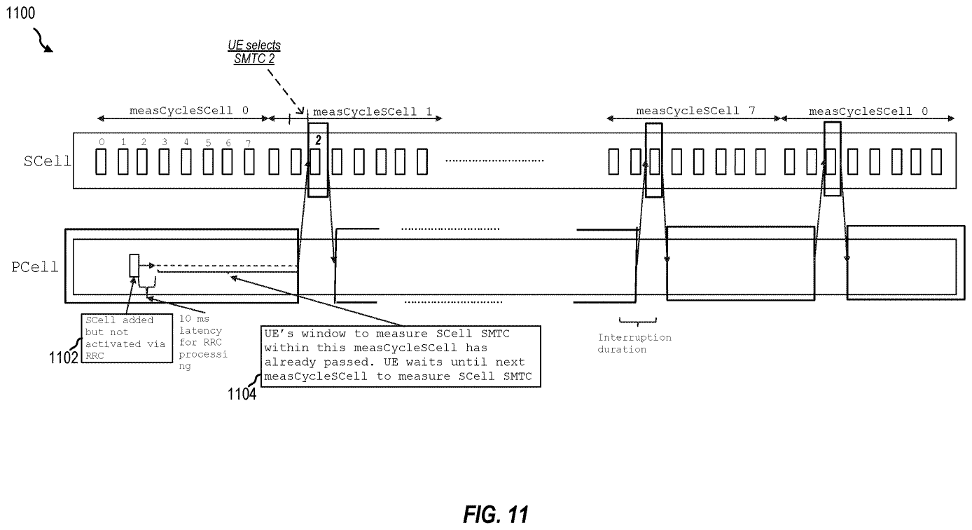

to select the specific SMTC. This may be understood with reference to diagram 1100 of FIG. 11. As indicated at 1102, the example assumes an SCell is added, but not yet activated. In the example illustrated in FIG. 11, network configured parameter_x mod (measCycleSCell period/SMTC period)=2. Thus, as illustrated, the UE selects SMTC 2. As with the previous example, as indicated at 1104, the UE's window to measure SCell SMTC within measCycleSCell_0 has already passed. Thus, the UE may wait until a next measCycleSCell to measure SCell SMTC.

The equations described above may limit the UE's flexibility to select an SMTC within a measCycleSCell. Further, as noted in FIGS. 10 and 11, the UE may also have to delay measurement by one measCycleSCell to select an SMTC according to spec defined or network indicated rule.

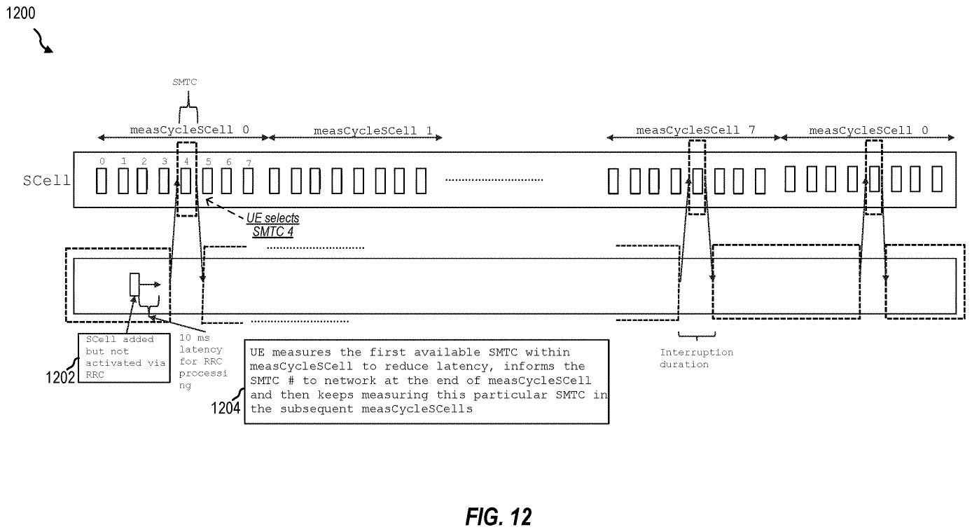

According to another solution, illustrated in diagram 1200 of FIG. 12, after receiving SCell addition command (in measCycleSCell_0), where SCell is not activated (as indicated at 1202), the UE can also select the specific SCell SMTC within the same measCycleSCell (measCycleSCell) on its own. In the illustrated example, the UE selects SMTC 4.

As indicated at 1204, at the end of the measCycleSCell, the UE may convey its selected SMTC index (SMTC 4) within the measCycleSCell to the network. As illustrated, the UE measures the same SMTC in the subsequent measCycleSCells. Since the network has been informed on the selected SMTC (4), the network may take this into consideration and only stop scheduling for the UE for this SMTC but not others.

As described herein, a UE may be allowed to interrupt operations with a PCell and/or active SCell adjacent to the SCell SMTC during deactivated SCell measurement. In this scenario, the location of the interruption may depend on at least one of: a status of the time synchronization between the serving cell (e.g., PCell) and the deactivated SCell or a reason for the deactivated SCell measurement.

For example, if the PCell and SCell are time synchronized, if the SCell is measured only to reduce SCell activation time, the UE may only need to measure the serving SSB of SCell. In this case, interruption may occur adjacent to the serving SSB. In one solution, the network may explicitly configure the UE to measure specific SSBs within an SMTC. In such cases, the UE may cause interruption adjacent to the indicated SSBs. If the SCell is measured for another reason (e.g., to measure neighbor SCells for mobility), then SSBs during the whole SMTC duration may need to be measured. In such cases, interruption may be allowed adjacent to SMTC occasions.

If the PCell and SCell are not time synchronized, then SSBs during the whole SMTC duration may need to be measured. In this case, interruption may be allowed adjacent to SMTC occasions.

According to certain aspects, a UE may be configured to determine an allowable percentage (or ratio) of missed acknowledgment (ACK/NACK) feedback during an interruption. This may be beneficial because different percentages may be suitable for different scenarios.

For example, assuming the following: measCycleSCell=160 ms, SMTC duration=5 ms, and that PCell and SCells are not synchronous, the UE may need a full SMTC duration plus at least one additional slot (5 ms+1 ms) to measure the deactivated SCell. In this case, the missed ACK/NACK percentage could be >3.5% (e.g., 6 ms/160 ms=3.75). Hence, with this configuration, at least a 3.5% missed ACK/NACK should be allowed. On the other hand, with longer measCycleSCell (e.g., 640 ms), a lower percentage of ACK/NACK of <1% may be permitted (e.g., based on 6 ms/640 ms).

In some cases, the allowed ratio of missed ACK/NACK feedback may also depend on other factors. These other factors may include, for example, whether the UE needs the whole SMTC duration to measure SCell.

According to certain aspects, the allowed ratio of missed ACK/NACK within a measCycleSCell may also depend on one or more other factors. For example, in some cases, a standard specification may define a rule that determines the ratio based one or more of the following factors (e.g., which may be network-indicated):
SMTC duration,
measCycleSCell,
Whether PCell and SCell are co-located and/or time-synced or not, or
Whether the deactivated SCell is being measured to reduce SCell activation time or to ensure mobility to other cells.

For example, if the two cells are time synchronized, the UE may only need to measure one SSB of SCell. On the other hand, if the two cells are not time synchronized, the UE may need to stay in SCell during the entire SMTC window of SCell.

If the deactivated SCell is being measured to reduce SCell activation time, if the deactivated SCell is time synchronized with PCell and if it is being measured only to reduce SCell activation timeline, the UE may only need to measure one SSB of SCell. On the other hand, if the UE is allowed to be handed over to a neighbor SCell as PCell, the UE may need to measure the deactivated SCell for the entire duration of SMTC, even if the PCell and SCell are time synchronized.

### Example Operations

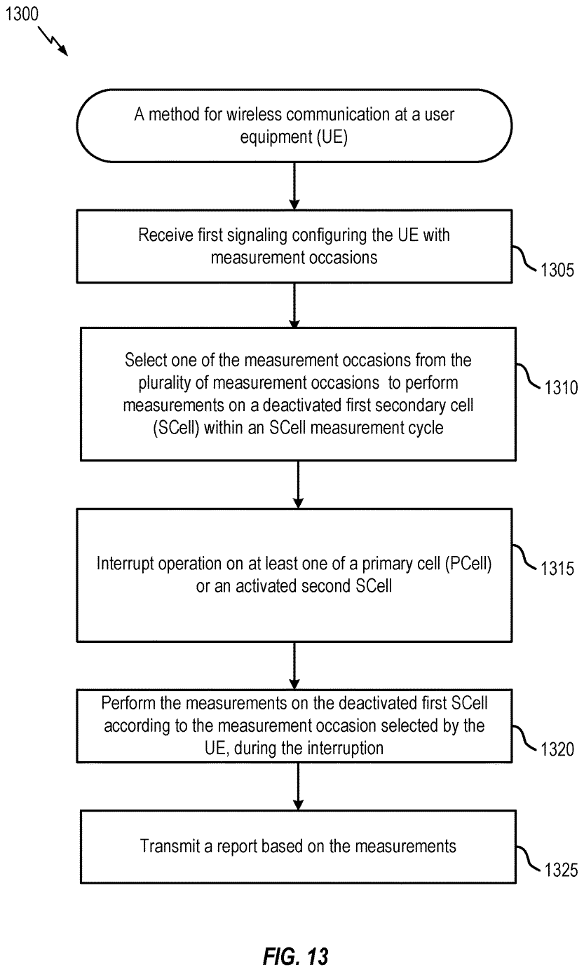

FIG. 13 shows an example of a method 1300 of wireless communication at a user equipment (UE), such as a UE 104 of FIGS. 1 and 3.

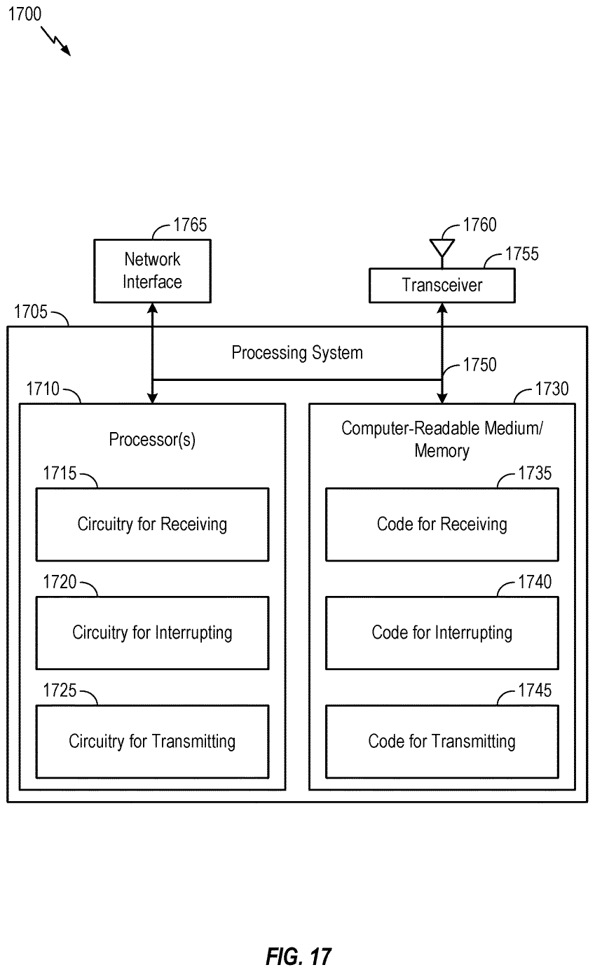

Method 1300 begins at step 1305 with receiving first signaling configuring the UE with a plurality of measurement occasions. In some cases, the operations of this step refer to, or may be performed by, circuitry for receiving and/or code for receiving as described with reference to FIG. 17.

Method 1300 then proceeds to step 1310 with selecting one of the measurement occasions from the plurality of measurement occasions to perform measurements on a deactivated first secondary cell (SCell) within an SCell measurement cycle. In some cases, the operations of this step refer to, or may be performed by, circuitry for interrupting and/or code for interrupting as described with reference to FIG. 17.

Method 1300 then proceeds to step 1315 with interrupting operation on at least one of a primary cell (PCell) or an activated second SCell. In some cases, the operations of this step refer to, or may be performed by, circuitry for transmitting and/or code for transmitting as described with reference to FIG. 17.

Method 1300 then proceeds to step 1320 with performing the measurements on the deactivated first SCell according to the measurement occasion selected by the UE, during the interruption. In some cases, the operations of this step refer to, or may be performed by, circuitry for transmitting and/or code for transmitting as described with reference to FIG. 17.

Method 1300 then proceeds to step 1325 with transmitting a report based on the measurements. In some cases, the operations of this step refer to, or may be performed by, circuitry for transmitting and/or code for transmitting as described with reference to FIG. 17.

In some aspects, the measurement occasions comprise signal block (SSB)-based radio resource management (RRM) Measurement Timing Configuration (SMTC) window occasions; and the measurements comprise measurements of SSBs.

In some aspects, the UE selects the measurement occasion based on a rule.

In some aspects, the rule involves at least one parameter.

In some aspects, the at least one parameter comprises at least one of: an identity of the UE; or an index assigned to the SCell measurement cycle.

In some aspects, the at least one parameter comprises a network configured parameter.

In some aspects, the rule is: defined via a standard specification; or network indicated.

In some aspects, timing of the interruption based on at least one of: a status of time synchronization between the PCell and the deactivated SCell; or a purpose for performing the measurements.

In some aspects, timing of the interruption is adjacent to selected SSBs within the selected measurement occasion.

In some aspects, the timing of the interruption is adjacent to selected SSBs within the selected measurement occasion if: the PCell and deactivated SCell are synchronized, and the purpose for performing the measurements is to reduce activation time of the deactivated SCell.

In some aspects, the SSBs are selected based on network indication or a standard specification defined rule.

In some aspects, the UE selects the SSB that is quasi co-located (QCLed) to a reference signal associated with a transmission configuration indicator (TCI) state of its PCell.

In some aspects, timing of the interruption is adjacent to the selected measurement occasion.

In one aspect, method 1300, or any aspect related to it, may be performed by an apparatus, such as communications device 1700 of FIG. 17, which includes various components operable, configured, or adapted to perform the method 1300. Communications device 1700 is described below in further detail.

Note that FIG. 13 is just one example of a method, and other methods including fewer, additional, or alternative steps are possible consistent with this disclosure.

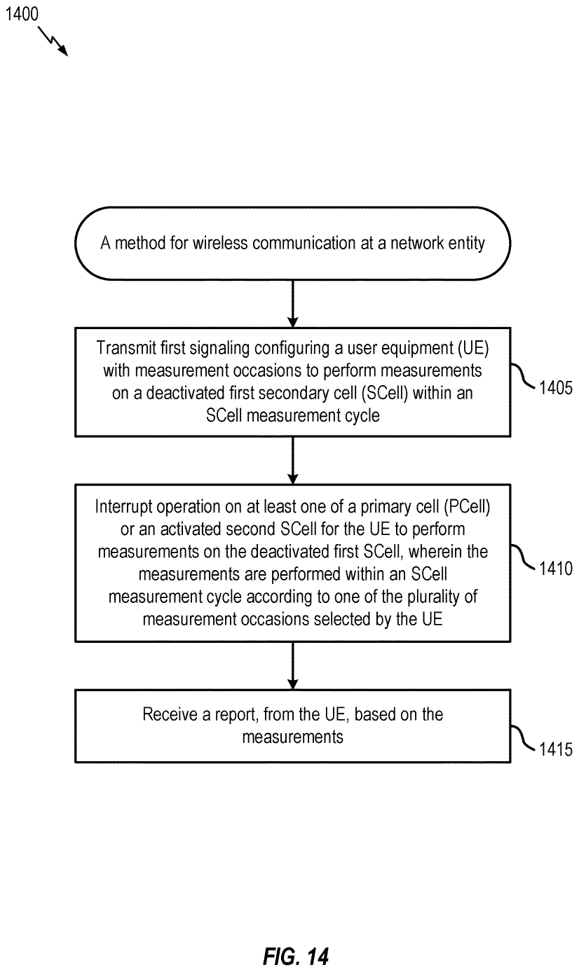

FIG. 14 shows an example of a method 1400 of wireless communication at a network entity, such as a BS 102 of FIGS. 1 and 3, or a disaggregated base station as discussed with respect to FIG. 2.

Method 1400 begins at step 1405 with transmitting first signaling configuring a user equipment (UE) with measurement occasions to perform measurements on a deactivated first secondary cell (SCell) within an SCell measurement cycle. In some cases, the operations of this step refer to, or may be performed by, circuitry for transmitting and/or code for transmitting as described with reference to FIG. 17.

Method 1400 then proceeds to step 1410 with interrupting operation on at least one of a primary cell (PCell) or an activated second SCell for the UE to perform measurements on the deactivated first SCell, wherein the measurements are performed within an SCell measurement cycle according to one of the plurality of measurement occasions selected by the UE. In some cases, the operations of this step refer to, or may be performed by, circuitry for interrupting and/or code for interrupting as described with reference to FIG. 17.

Method 1400 then proceeds to step 1415 with receiving a report, from the UE, based on the measurements. In some cases, the operations of this step refer to, or may be performed by, circuitry for receiving and/or code for receiving as described with reference to FIG. 17.

In some aspects, the measurement occasions comprise signal block (SSB)-based radio resource management (RRM) Measurement Timing Configuration (SMTC) window occasions; and the measurements comprise measurements of SSBs.

In some aspects, the measurement occasion is selected based on a rule.

In some aspects, the rule involves at least one parameter.

In some aspects, the at least one parameter comprises at least one of: an identity of the UE; or an index assigned to the SCell measurement cycle.

In some aspects, the at least one parameter comprises a network configured parameter.

In some aspects, the rule is: defined via a standard specification; or indicated by the network entity.

In some aspects, timing of the interruption based on at least one of: a status of time synchronization between the PCell and the deactivated SCell; or a purpose for performing the measurements.

In some aspects, the timing of the interruption is adjacent to selected SSBs within the selected measurement occasion, if the PCell and deactivated SCell are synchronized, and the purpose for performing the measurements is to reduce activation time of the deactivated SCell.

In some aspects, the timing of the interruption is adjacent to selected SSBs within the selected measurement occasion if: the PCell and deactivated SCell are synchronized, and the purpose for performing the measurements is to reduce activation time of the deactivated SCell.

In some aspects, the SSBs are selected based on network indication or a standard specification defined rule.

In some aspects, an SSB is selected that is quasi co-located (QCLed) to a reference signal associated with a transmission configuration indicator (TCI) state of the UE's PCell.

In some aspects, timing of the interruption is adjacent to the selected measurement occasion.

In one aspect, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative steps are possible consistent with this disclosure.

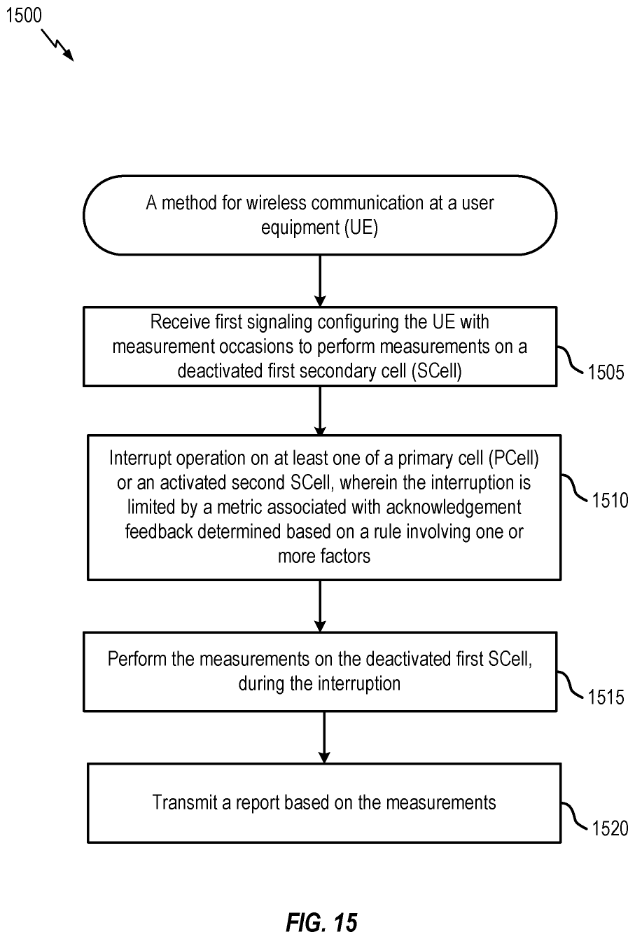

FIG. 15 shows an example of a method 1500 of wireless communication at a user equipment (UE), such as a UE 104 of FIGS. 1 and 3.

Method 1500 begins at step 1505 with receiving first signaling configuring the UE with measurement occasions to perform measurements on a deactivated first secondary cell (SCell). In some cases, the operations of this step refer to, or may be performed by, circuitry for receiving and/or code for receiving as described with reference to FIG. 17.

Method 1500 then proceeds to step 1510 with interrupting operation on at least one of a primary cell (PCell) or an activated second SCell, wherein the interruption is limited by a metric associated with acknowledgement feedback determined based on a rule involving one or more factors. In some cases, the operations of this step refer to, or may be performed by, circuitry for interrupting and/or code for interrupting as described with reference to FIG. 17.

Method 1500 then proceeds to step 1515 with performing the measurements on the deactivated first SCell, during the interruption. In some cases, the operations of this step refer to, or may be performed by, circuitry for transmitting and/or code for transmitting as described with reference to FIG. 17.

Method 1500 then proceeds to step 1520 with transmitting a report based on the measurements. In some cases, the operations of this step refer to, or may be performed by, circuitry for transmitting and/or code for transmitting as described with reference to FIG. 17.

In some aspects, the metric comprises a ratio of missed acknowledgment feedback within the SCell measurement cycle.

In some aspects, the one or more factors involve at least one of: whether the PCell and deactivated SCell are co-located; or whether the PCell and deactivated SCell are time synchronized.

In some aspects, the measurement occasions comprise signal block (SSB)-based radio resource management (RRM) Measurement Timing Configuration (SMTC) window occasions; and the measurements comprise measurements of SSBs.

In some aspects, the one or more factors involve at least one of: durations of the SSBs within the measurement occasion that need to be measured; a duration of the SMTC occasions; or a duration of the SCell measurement cycle.

In some aspects, the method 1500 further includes receiving signaling indicating the one or more factors. In some cases, the operations of this step refer to, or may be performed by, circuitry for receiving and/or code for receiving as described with reference to FIG. 17.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

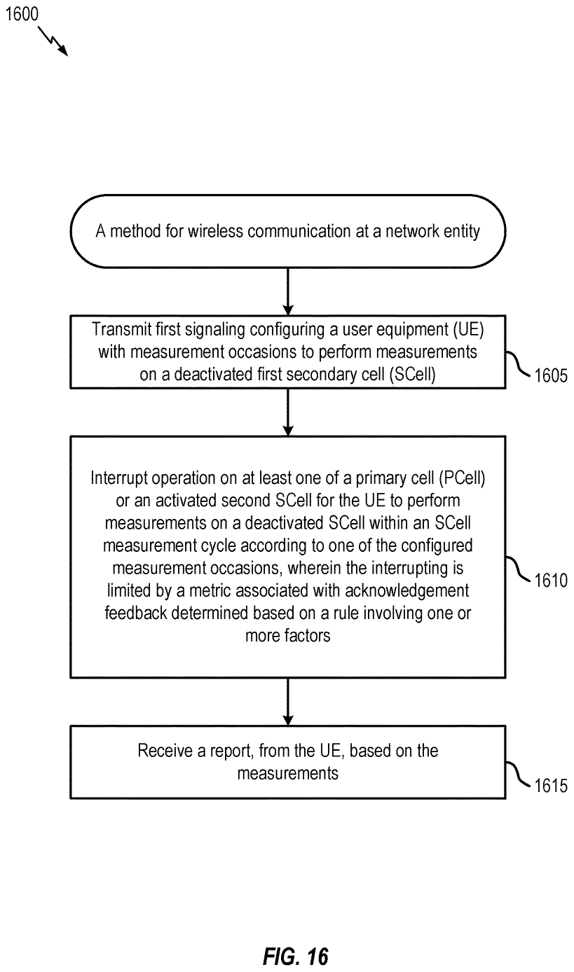

FIG. 16 shows an example of a method 1600 of wireless communication at a network entity, such as a BS 102 of FIGS. 1 and 3, or a disaggregated base station as discussed with respect to FIG. 2.

Method 1600 begins at step 1605 with transmitting first signaling configuring a user equipment (UE) with measurement occasions to perform measurements on a deactivated first secondary cell (SCell). In some cases, the operations of this step refer to, or may be performed by, circuitry for transmitting and/or code for transmitting as described with reference to FIG. 17.

Method 1600 then proceeds to step 1610 with interrupting operation on at least one of a primary cell (PCell) or an activated second SCell for the UE to perform measurements on a deactivated SCell within an SCell measurement cycle according to one of the configured measurement occasions, wherein the interrupting is limited by a metric associated with acknowledgement feedback determined based on a rule involving one or more factors. In some cases, the operations of this step refer to, or may be performed by, circuitry for interrupting and/or code for interrupting as described with reference to FIG. 17.

Method 1600 then proceeds to step 1615 with receiving a report, from the UE, based on the measurements. In some cases, the operations of this step refer to, or may be performed by, circuitry for receiving and/or code for receiving as described with reference to FIG. 17.

In some aspects, the metric comprises a ratio of missed acknowledgment feedback within the SCell measurement cycle.

In some aspects, the one or more factors involve at least one of: whether the PCell and deactivated SCell are co-located; or whether the PCell and deactivated SCell are time synchronized.

In some aspects, the measurement occasions comprise signal block (SSB)-based radio resource management (RRM) Measurement Timing Configuration (SMTC) window occasions; and the measurements comprise measurements of SSBs.

In some aspects, the one or more factors involve at least one of: durations of the SSBs within the measurement occasion that need to be measured; a duration of the SMTC occasions; or a duration of the SCell measurement cycle.

In some aspects, the method 1600 further includes transmitting signaling indicating the one or more factors. In some cases, the operations of this step refer to, or may be performed by, circuitry for transmitting and/or code for transmitting as described with reference to FIG. 17.

In one aspect, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative steps are possible consistent with this disclosure.

### Example Communications Device(s)

FIG. 17 depicts aspects of an example communications device 1700. In some aspects, communications device 1700 is a user equipment, such as UE 104 described above with respect to FIGS. 1 and 3. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1755 (e.g., a transmitter and/or a receiver). In some aspects (e.g., when communications device 1700 is a network entity), processing system 1705 may be coupled to a network interface 1765 that is configured to obtain and send signals for the communications device 1700 via communication link(s), such as a backhaul link, midhaul link, and/or fronthaul link as described herein, such as with respect to FIG. 2. The transceiver 1755 is configured to transmit and receive signals for the communications device 1700 via the antenna 1760, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1730 via a bus 1750. In certain aspects, the computer-readable medium/memory 1730 is configured to store instructions (e.g., computer-executable code) that when executed by the one or more processors 1710, cause the one or more processors 1710 to perform the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it. Note that reference to a processor performing a function of communications device 1700 may include one or more processors 1710 performing that function of communications device 1700.

In the depicted example, computer-readable medium/memory 1730 stores code (e.g., executable instructions), such as code for receiving 1735, code for interrupting 1740, and code for transmitting 1745. Processing of the code for receiving 1735, code for interrupting 1740, and code for transmitting 1745 may cause the communications device 1700 to perform the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it.

The one or more processors 1710 include circuitry configured to implement (e.g., execute) the code stored in the computer-readable medium/memory 1730, including circuitry for receiving 1715, circuitry for interrupting 1720, and circuitry for transmitting 1725. Processing with circuitry for receiving 1715, circuitry for interrupting 1720, and circuitry for transmitting 1725 may cause the communications device 1700 to perform the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it.

Various components of the communications device 1700 may provide means for performing the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1755 and the antenna 1760 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1755 and the antenna 1760 of the communications device 1700 in FIG. 17.

### Example Clauses

Implementation examples are described in the following numbered clauses:
Clause 1: A method for wireless communication at a user equipment (UE), comprising: receiving first signaling configuring the UE with a plurality of measurement occasions, selecting one of the measurement occasions from the plurality of measurement occasions to perform measurements on a deactivated first secondary cell (SCell) within an SCell measurement cycle, interrupting operation on at least one of a primary cell (PCell) or an activated second SCell, performing the measurements on the deactivated first SCell according to the measurement occasion selected by the UE, during the interruption, and transmitting a report based on the measurements.
Clause 2: The method of Clause 1, wherein: the measurement occasions comprise signal block (SSB)-based radio resource management (RRM) Measurement Timing Configuration (SMTC) window occasions; and the measurements comprise measurements of SSBs.
Clause 3: The method of any one of Clauses 1-2, wherein the UE selects the measurement occasion based on a rule.
Clause 4: The method of Clause 3, wherein the rule involves at least one parameter.
Clause 5: The method of Clause 4, wherein the at least one parameter comprises at least one of: an identity of the UE; or an index assigned to the SCell measurement cycle.
Clause 6: The method of Clause 4, wherein: the at least one parameter comprises a network configured parameter.
Clause 7: The method of Clause 4, wherein the rule is: defined via a standard specification; or network indicated.
Clause 8: The method of Clause 4, wherein timing of the interruption based on at least one of: a status of time synchronization between the PCell and the deactivated SCell; or a purpose for performing the measurements.
Clause 9: The method of Clause 4, wherein timing of the interruption is adjacent to selected SSBs within the selected measurement occasion.
Clause 10: The method of Clause 9, wherein the timing of the interruption is adjacent to selected SSBs within the selected measurement occasion if: the PCell and deactivated SCell are synchronized, and the purpose for performing the measurements is to reduce activation time of the deactivated SCell.
Clause 11: The method of Clause 9, wherein the SSBs are selected based on network indication or a standard specification defined rule.
Clause 12: The method of Clause 11, wherein the UE selects the SSB that is quasi co-located (QCLed) to a reference signal associated with a transmission configuration indicator (TCI) state of its PCell.
Clause 13: The method of Clause 4, wherein timing of the interruption is adjacent to the selected measurement occasion.
Clause 14: The method of Clause 13, wherein the timing of the interruption is adjacent to the selected measurement occasion, if the PCell and deactivated SCell are unsynchronized or if a purpose for performing the measurements is for mobility.
Clause 15: A method for wireless communication at a network entity, comprising: transmitting first signaling configuring a user equipment (UE) with measurement occasions to perform measurements on a deactivated first secondary cell (SCell) within an SCell measurement cycle, interrupting operation on at least one of a primary cell (PCell) or an activated second SCell for the UE to perform measurements on the deactivated first SCell, wherein the measurements are performed within an SCell measurement cycle according to one of the plurality of measurement occasions selected by the UE, and receiving a report, from the UE, based on the measurements.
Clause 16: The method of Clause 15, wherein: the measurement occasions comprise signal block (SSB)-based radio resource management (RRM) Measurement Timing Configuration (SMTC) window occasions; and the measurements comprise measurements of SSBs.
Clause 17: The method of any one of Clauses 15-16, wherein the measurement occasion is selected based on a rule.
Clause 18: The method of Clause 17, wherein the rule involves at least one parameter.
Clause 19: The method of Clause 18, wherein the at least one parameter comprises at least one of: an identity of the UE; or an index assigned to the SCell measurement cycle.
Clause 20: The method of Clause 18, wherein: the at least one parameter comprises a network configured parameter.
Clause 21: The method of Clause 18, wherein the rule is: defined via a standard specification; or indicated by the network entity.
Clause 22: The method of Clause 18, wherein timing of the interruption based on at least one of: a status of time synchronization between the PCell and the deactivated SCell; or a purpose for performing the measurements.
Clause 23: The method of Clause 22, wherein the timing of the interruption is adjacent to selected SSBs within the selected measurement occasion, if the PCell and deactivated SCell are synchronized, and the purpose for performing the measurements is to reduce activation time of the deactivated SCell.
Clause 24: The method of Clause 23, wherein the timing of the interruption is adjacent to selected SSBs within the selected measurement occasion if: the PCell and deactivated SCell are synchronized, and the purpose for performing the measurements is to reduce activation time of the deactivated SCell.
Clause 25: The method of Clause 23, wherein the SSBs are selected based on network indication or a standard specification defined rule.
Clause 26: The method of Clause 25, wherein an SSB is selected that is quasi co-located (QCLed) to a reference signal associated with a transmission configuration indicator (TCI) state of the UE's PCell.
Clause 27: The method of Clause 18, wherein timing of the interruption is adjacent to the selected measurement occasion.
Clause 28: The method of Clause 27, wherein the timing of the interruption is adjacent to the selected measurement occasion, if the PCell and deactivated SCell are unsynchronized or if a purpose for performing the measurements is for mobility.
Clause 29: A method for wireless communication at a user equipment (UE), comprising: receiving first signaling configuring the UE with measurement occasions to perform measurements on a deactivated first secondary cell (SCell), interrupting operation on at least one of a primary cell (PCell) or an activated second SCell, wherein the interruption is limited by a metric associated with acknowledgement feedback determined based on a rule involving one or more factors, performing the measurements on the deactivated first SCell, during the interruption, and transmitting a report based on the measurements.
Clause 30: The method of Clause 29, wherein the metric comprises a ratio of missed acknowledgment feedback within the SCell measurement cycle.
Clause 31: The method of any one of Clauses 29-30, wherein: the measurement occasions comprise signal block (SSB)-based radio resource management (RRM) Measurement Timing Configuration (SMTC) window occasions; and the measurements comprise measurements of SSBs.
Clause 32: The method of Clause 31, wherein the one or more factors involve at least one of: durations of the SSBs within the measurement occasion that need to be measured; a duration of the SMTC occasions; or a duration of the SCell measurement cycle.
Clause 33: The method of Clause 30, wherein the one or more factors involve at least one of: whether the PCell and deactivated SCell are co-located; or whether the PCell and deactivated SCell are time synchronized.
Clause 34: The method of any one of Clauses 29-33, further comprising receiving signaling indicating the one or more factors.
Clause 35: The method of Clause 30, wherein more than two ratios are allowed based on a defined rule or a network indication.
Clause 36: A method for wireless communication at a network entity, comprising: transmitting first signaling configuring a user equipment (UE) with measurement occasions to perform measurements on a deactivated first secondary cell (SCell), interrupting operation on at least one of a primary cell (PCell) or an activated second SCell for the UE to perform measurements on a deactivated SCell within an SCell measurement cycle according to one of the configured measurement occasions, wherein the interrupting is limited by a metric associated with acknowledgement feedback determined based on a rule involving one or more factors, and receiving a report, from the UE, based on the measurements.
Clause 37: The method of Clause 36, wherein the metric comprises a ratio of missed acknowledgment feedback within the SCell measurement cycle.
Clause 38: The method of any one of Clauses 36-37, wherein: the measurement occasions comprise signal block (SSB)-based radio resource management (RRM) Measurement Timing Configuration (SMTC) window occasions; and the measurements comprise measurements of SSBs.
Clause 39: The method of Clause 38, wherein the one or more factors involve at least one of: durations of the SSBs within the measurement occasion that need to be measured; a duration of the SMTC occasions; or a duration of the SCell measurement cycle.
Clause 40: The method of Clause 37, wherein the one or more factors involve at least one of: whether the PCell and deactivated SCell are co-located; or whether the PCell and deactivated SCell are time synchronized.
Clause 41: The method of any one of Clauses 36-40, further comprising transmitting signaling indicating the one or more factors.
Clause 42: The method of Clause 37, wherein more than two ratios are allowed based on a defined rule or a network indication.
Clause 43: An apparatus, comprising: at least one memory comprising executable instructions; and at least one processor configured to execute the executable instructions and cause the apparatus to perform a method in accordance with any combination of Clauses 1-42.
Clause 44: An apparatus, comprising means for performing a method in accordance with any combination of Clauses 1-42.
Clause 45: A non-transitory computer-readable medium comprising executable instructions that, when executed by at least one processor of an apparatus, cause the apparatus to perform a method in accordance with any combination of Clauses 1-42.
Clause 46: A computer program product embodied on a computer-readable storage medium comprising code for performing a method in accordance with any combination of Clauses 1-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for interrupting, and means for transmitting may comprise one or more processors, such as one or more of the processors described above with reference to FIG. 17.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive first signaling configuring the UE with measurement occasions to perform measurements on a deactivated first secondary cell (SCell);
interrupt operation on at least one of a primary cell (PCell) or an activated second SCell, wherein the interruption is limited by a metric associated with acknowledgement feedback determined based on a rule involving one or more factors;
perform the measurements on the deactivated first SCell, during the interruption; and
transmit a report based on the measurements.

2. The apparatus of claim 1, wherein the metric comprises a ratio of missed acknowledgment feedback within the SCell measurement cycle.

3. The apparatus of claim 1, wherein:
the measurement occasions comprise signal block (SSB)-based radio resource management (RRM) Measurement Timing Configuration (SMTC) window occasions; and
the measurements comprise measurements of SSBs.

4. The apparatus of claim 3, wherein the one or more factors involve at least one of:
durations of the SSBs within the measurement occasion that need to be measured; a duration of the SMTC occasions; or
a duration of the SCell measurement cycle.

5. The apparatus of claim 2, wherein the one or more factors involve at least one of:
whether the PCell and deactivated first SCell are co-located; or
whether the PCell and deactivated first SCell are time synchronized.

6. The apparatus of claim 1, wherein the one or more processors are further configured to cause the apparatus to:
receive signaling indicating the one or more factors.

7. The apparatus of claim 2, wherein more than two ratios are allowed based on a defined rule or a network indication.

8. An apparatus for wireless communication at a network entity, comprising:
at least one memory comprising computer-executable instructions; and
one or more processors configured to execute the computer-executable instructions and cause the apparatus to:
transmit first signaling configuring a user equipment (UE) with measurement occasions to perform measurements on a deactivated first secondary cell (SCell);
interrupt operation on at least one of a primary cell (PCell) or an activated second SCell for the UE to perform measurements on a deactivated SCell within an SCell measurement cycle according to one of the configured measurement occasions, wherein the interrupting is limited by a metric associated with acknowledgement feedback determined based on a rule involving one or more factors; and
receive a report, from the UE, based on the measurements.

9. The apparatus of claim 8, wherein the metric comprises a ratio of missed acknowledgment feedback within the SCell measurement cycle.

10. The apparatus of claim 8, wherein:
the measurement occasions comprise signal block (SSB)-based radio resource management (RRM) Measurement Timing Configuration (SMTC) window occasions; and
the measurements comprise measurements of SSBs.

11. The apparatus of claim 10, wherein the one or more factors involve at least one of:
durations of the SSBs within the measurement occasion that need to be measured; a duration of the SMTC occasions; or
a duration of the SCell measurement cycle.

12. The apparatus of claim 9, wherein the one or more factors involve at least one of:
whether the PCell and deactivated first SCell are co-located; or
whether the PCell and deactivated first SCell are time synchronized.

13. The apparatus of claim 8, wherein the one or more processors are further configured to cause the apparatus to:
transmit signaling indicating the one or more factors.

14. The apparatus of claim 9, wherein more than two ratios are allowed based on a defined rule or a network indication.

15. An apparatus for wireless communication at a user equipment (UE), comprising:
at least one memory comprising computer-executable instructions; and
one or more processors configured to execute the computer-executable instructions and cause the apparatus to:
receive first signaling configuring the UE with a plurality of measurement occasions;
select one of the measurement occasions from the plurality of measurement occasions to perform measurements on a deactivated first secondary cell (SCell) within an SCell measurement cycle;
interrupt operation on at least one of a primary cell (PCell) or an activated second SCell;
perform the measurements on the deactivated first SCell according to the measurement occasion selected by the UE, during the interruption; and
transmit a report based on the measurements.

16. The apparatus of claim 15, wherein:
the measurement occasions comprise signal block (SSB)-based radio resource management (RRM) Measurement Timing Configuration (SMTC) window occasions; and
the measurements comprise measurements of SSBs.

17. The apparatus of claim 15, wherein the UE selects the measurement occasion based on a rule.

18. The apparatus of claim 17, wherein the rule involves at least one parameter.

19. The apparatus of claim 18, wherein the at least one parameter comprises at least one of:
an identity of the UE; or
an index assigned to the SCell measurement cycle.

20. The apparatus of claim 18, wherein the at least one parameter comprises a network configured parameter.
